(19) United States
(12) Patent Application Publication
(10) Pub. No.: US 2014/0229875 A1
(43) Pub. Date: Aug. 14, 2014

(54) CONTENT BASED DYNAMIC CONTROL FOR DISPLAY BRIGHTNESS

(71) Applicants: Wenlong Li, Beijing (CN); Xiao Feng Xiao-Feng Li, Beijing (CN); Haitao Feng, Beijing (CN)

(72) Inventors: Wenlong Li, Beijing (CN); Xiao Feng Xiao-Feng Li, Beijing (CN); Haitao Feng, Beijing (CN)

(21) Appl. No.: 13/994,206

(22) PCT Filed: Sep. 28, 2012
(86) PCT No.: PCT/CN2012/082307

§ 371 Date: Jun. 14, 2013

(51) Int. Cl. G06F 3/0484

(52) U.S. Cl. CPC G06F 3/0484
USPC 715/771

(57) ABSTRACT

Generally, this disclosure provides methods and systems for dynamic control of display brightness in different regions of the display based on window configuration and content. The method may include determining regions of interest to a user on the display; adjusting the display brightness in the regions of interest to a first level of brightness; and adjusting the display brightness in regions outside of the regions of interest to a second level of brightness, such that the second level of brightness is lower than the first level of brightness. The dynamic adjustment of display brightness in different regions of the display may reduce power consumption by the display.

### FIELD

The present disclosure relates to display brightness control, and more particularly, to dynamic display brightness control based on configuration and content of windows.

### BACKGROUND

Many electronic devices, and especially mobile devices such as laptops, tablets and smartphones, rely on battery power which can be a limiting factor in the use of the device. Larger batteries are heavier and take up more space which adversely affects the quality of the user experience with the device. For this and other reasons, an effort is typically made to design electronic devices with the goal of reducing power consumption. The screen display of most devices is the component that often consumes the greatest share of power. Some existing devices employ an ambient light sensor to adapt the screen brightness level to environmental lighting conditions to reduce power consumption. This solution, however, still employs a uniform brightness level for all pixels of the display.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a top level system diagram of one exemplary embodiment consistent with the present disclosure;

FIG. 2 illustrates z-order and overlap of windows consistent with an exemplary embodiment of the present disclosure;

FIG. 3 illustrates content ranking of windows consistent with an exemplary embodiment of the present disclosure;

FIG. 4 illustrates block diagram of one exemplary embodiment consistent with the present disclosure; and

FIG. 5 illustrates a flowchart of operations of an exemplary embodiment consistent with the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure provides methods and systems for dynamic control of display brightness over different regions of a display based on the configuration and content of windows being displayed. The location, size and z-order of the windows may be determined and this information used to select regions of the display that are of reduced interest to the user at any given time. The display brightness for these selected regions may then be lowered to reduce power consumption. Regions of interest to the user may also be determined based on content ranking of material displayed within each window. The content ranking may be based on profiles of the applications that generate the windows and the window contents.

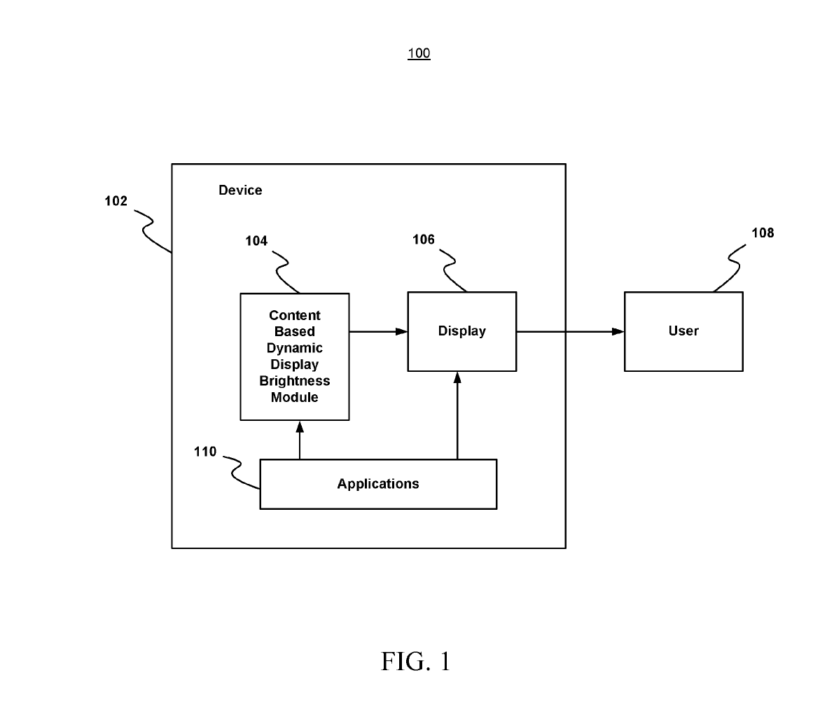

FIG. 1 illustrates a top level system diagram 100 of one exemplary embodiment consistent with the present disclosure. A device 102 includes a display 106 which is configured to present visual information to a user 108. The device 102 may be any type of computing, communication, entertainment or other type of device that comprises a display, screen or graphical user interface (GUI) of any type, such as, for example, a computer, a laptop, a tablet, a smartphone, media player or personal digital assistant. Portions of the visual information may be presented in the format of one or more windows that may overlap to varying extents. The windows and their content may be generated by applications 110 or other software modules or operating system components that run on or are otherwise associated with the device 102. Content based dynamic display brightness module 104 may be configured to dynamically adjust the brightness level of different regions on the display 106 based on the, possibly varying, configuration and contents of the windows being displayed. These brightness level adjustments may be performed to reduce power consumption of the device 102 as will be explained in greater detail below.

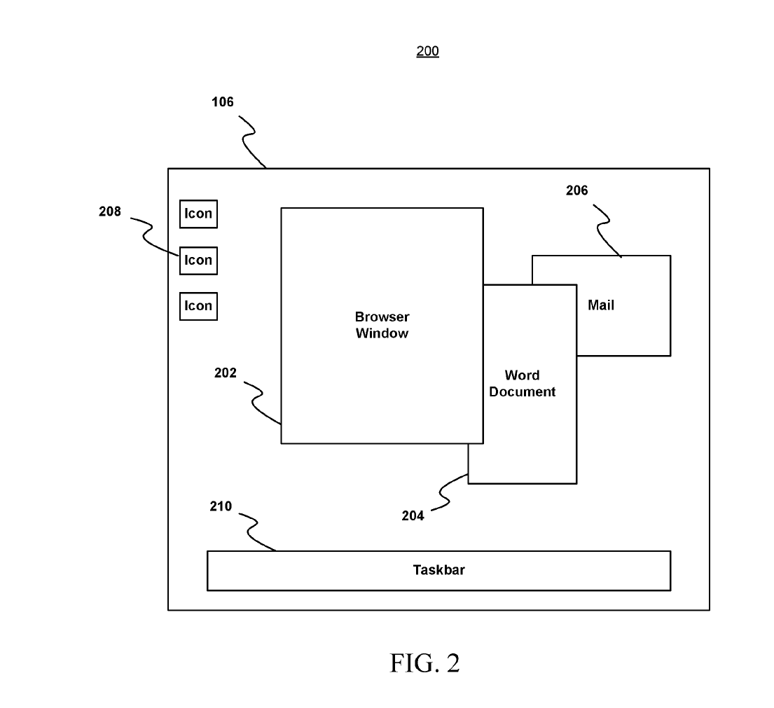

FIG. 2 illustrates z-order and overlap of windows 200 consistent with an exemplary embodiment of the present disclosure. Display 106 is shown to present a number of windows and other exemplary visual information for user 108. The windows may be any type of window, such as, for example, a browser window 202, a word processing document 204 and a mail window 206. Other objects to be displayed may include, for example, a taskbar 210 and icons 208. It will be appreciated that any number and type of visual presentation objects may be displayed to the user 108.

The windows, or other objects to be displayed, may overlap. The z-order determines the overlay ordering of each window, or in other words, the position of the window along the z-axis (i.e., the axis directed outward from the screen surface as opposed to the x and y axes which lie in the plane of the screen surface). The z-order therefore determines which window appears on top of any other overlapping window (i.e., in the foreground versus the background). The user may typically select a window to be brought to the foreground. This foreground window may often be assumed to be a window of current interest to the user or the area of user focus. A window manager, task stack or other operating system component, may generally handle the ordering and display of windows based on the user selection.

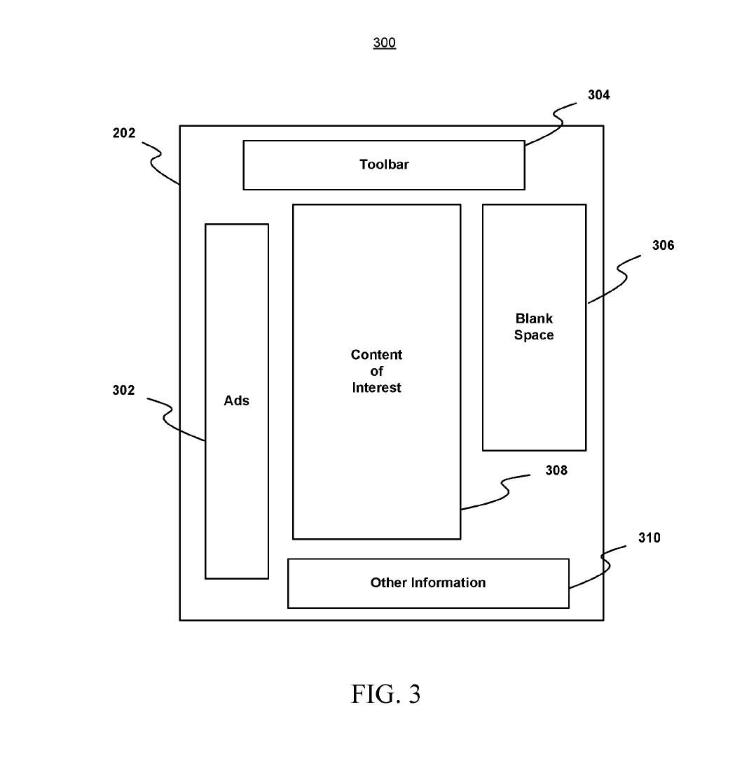

FIG. 3 illustrates content ranking of windows 300 consistent with an exemplary embodiment of the present disclosure. A window, for example the browser window 202, is shown to comprise a toolbar 304, a content of interest region 308, a blank space region 306, advertisements 302 and other information 310. The content of interest region 308 represents the area or areas within the window 202 where information or content that is of greatest interest to the user is located. For example, if the window is a browser and the user is performing an interne search, the content of interest region 308 may contain the search results. As a further example, if the window is a word processing document the content of interest region may be the paragraph containing the cursor or the paragraph currently being edited.

Many web pages, including search engines, display advertisements 302 along with the content of interest. These advertisements may typically appear in a region such as for example, the left hand side or the right hand side of the screen and may not be of primary interest to the user. Many web pages have areas of blank or otherwise unused space 306. These blank areas may be large and may typically be white or another bright color that consumes significant quantities of power to display. A toolbar region 304 and other information object regions 310 may also be present and may not be of primary interest to the user.

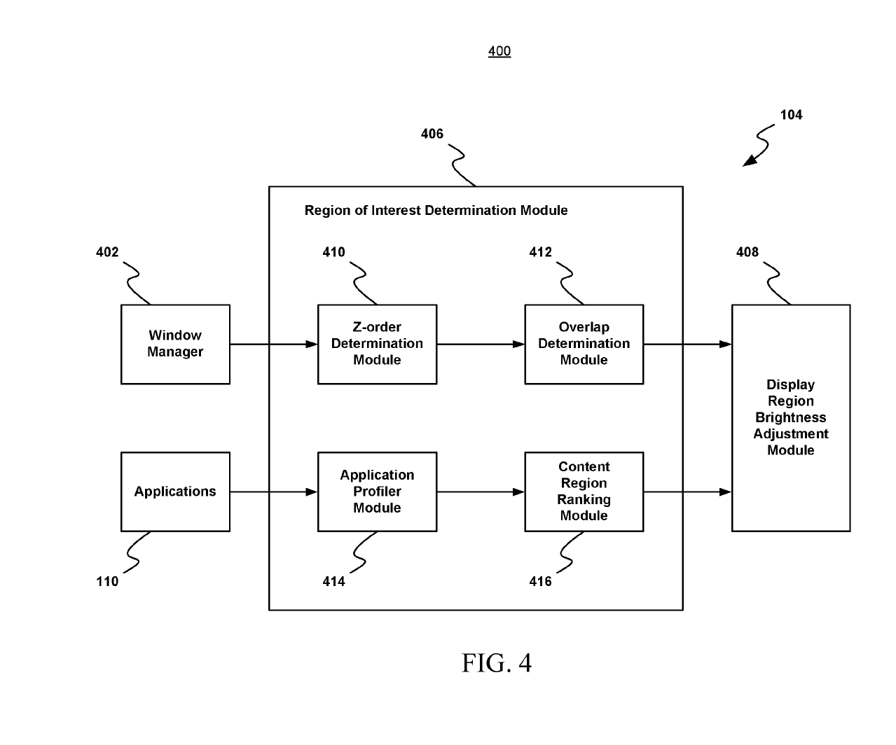

FIG. 4 illustrates block diagram 400 of one exemplary embodiment consistent with the present disclosure. Content based dynamic display brightness module 104 is shown to comprise region of interest determination module 406 and display region brightness adjustment module 408. Region of interest determination module 406 further comprises z-order determination module 410, overlap determination module 412, application profiler module 414 and content region ranking module 416.

Z-order determination module 410 may be configured to obtain the z-order of windows, or other objects to be displayed, from window manager 402 to determine the foreground window or windows that may be of greatest interest to the user. Overlap determination module 412 may be configured to determine non-overlapping areas of non-foreground windows that do not overlap the foreground window based on the z-order information and the size and position of the windows. These regions are typically not the region of user focus and may be of lesser interest to the user. The resulting determination of windows, and associated regions, of greater and lesser interest may be passed to display region brightness adjustment module 408 which may be configured to dynamically adjust the brightness or color of these regions. The dynamic brightness adjustments may be set such that regions of greater interest or focus are brighter than regions of lesser interest which may be set to a dimmer level or a darker color.

Application profiler module 414 may be configured to generate a profile, or library of profiles, for the applications 110 that may run on the device 102. Application profiler module 414 may analyze the windows produced by applications 110 to determine the layout and location of different regions within those windows, e.g., 302, 304, 306, 308, 310. For example, a library of profiles may be built up for the web browsers, email applications, word processing applications, etc., that are used on the device. Content region ranking module 416 may be configured to rank the regions identified in the application profile to provide an indication of the relative level of importance or interest of each region to the user. For example, advertisement region 302 may be ranked lower that content of interest region 308. The resulting content ranking of regions within windows of greater and lesser interest may be passed to display region brightness adjustment module 408 which may be configured to dynamically adjust the brightness of these regions such that regions of greater interest are brighter than regions of lesser interest.

In some embodiments, the content region ranking analysis may be performed only on foreground windows while all background windows are set to a lower brightness level. In some embodiments any number brightness levels may be selected for use wherein each brightness level may be associated with a different level of interest for a region of the display. Brightness levels may be based on user input which may be adjusted dynamically, for example with a slider bar or other user interface tool. Brightness levels may also be based on preference settings which may be stored in a user preference database.

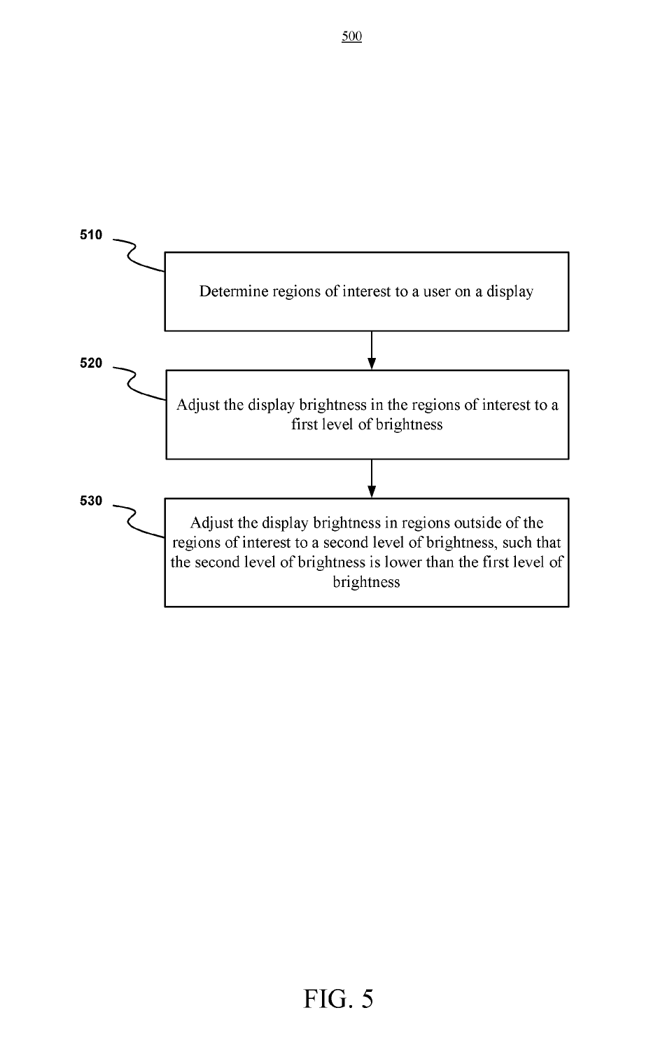

FIG. 5 illustrates a flowchart of operations 500 of an exemplary embodiment consistent with the present disclosure. At operation 510, regions of interest to a user on a display are determined. The determination may be based on the foreground/background position of windows. The determination may also be based on the content ranking of areas within the windows. At operation 520, the display brightness in the regions of interest is adjusted to a first level of brightness. At operation 530, the display brightness in regions outside of the regions of interest is adjusted to a second level of brightness. The second level of brightness is lower than the first level of brightness which may result in reduced power consumption. In some embodiments, the different levels of brightness may be selected by the user.

While FIG. 5 illustrates various operations according to one embodiment, it is to be understood that not all of these operations are necessary. Indeed, it is fully contemplated herein that in other embodiments of the present disclosure, the operations described herein may be combined in a manner not specifically shown in any of the drawings, but still fully consistent with the present disclosure. Thus, claims directed to features and/or operations that are not exactly shown in one drawing are deemed within the scope and content of the present disclosure.

Embodiments of the methods described herein may be implemented in a system that includes one or more storage mediums having stored thereon, individually or in combination, instructions that when executed by one or more processors perform the methods. Here, the processor may include, for example, a system CPU (e.g., core processor) and/or programmable circuitry. Thus, it is intended that operations according to the methods described herein may be distributed across a plurality of physical devices, such as processing structures at several different physical locations. Also, it is intended that the method operations may be performed individually or in a subcombination, as would be understood by one skilled in the art. Thus, not all of the operations of each of the flow charts need to be performed, and the present disclosure expressly intends that all subcombinations of such operations are enabled as would be understood by one of ordinary skill in the art.

The storage medium may include any type of tangible medium, for example, any type of disk including floppy disks, optical disks, compact disk read-only memories (CD-ROMS), compact disk rewritables (CD-RWs), digital versatile disks (DVDs) and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

“Circuitry”, as used in any embodiment herein, may comprise, for example, singly or in any combination, hardwired circuitry, programmable circuitry, state machine circuitry, and/or firmware that stores instructions executed by programmable circuitry. An app may be embodied as code or instructions which may be executed on programmable circuitry such as a host processor or other programmable circuitry. A module, as used in any embodiment herein, may be embodied as circuitry. The circuitry may be embodied as an integrated circuit, such as an integrated circuit chip.

Thus, the present disclosure provides methods and systems for dynamic control of display brightness in different regions of the display based on window configuration and content. According to one aspect there is provided a method. The method may include determining regions of interest to a user on the display. The method of this example may also include adjusting the display brightness in the regions of interest to a first level of brightness. The method of this example may further include adjusting the display brightness in regions outside of the regions of interest to a second level of brightness, and the second level of brightness is lower than the first level of brightness.

Another example method includes the forgoing operations and the determining of regions of interest further includes determining the z-order of a plurality of windows generated on the display.

Another example method includes the forgoing operations and further includes obtaining the z-order of the plurality of windows from a window manager.

Another example method includes the forgoing operations and the determining of regions of interest further includes determining the size and overlap of a plurality of windows generated on the display.

Another example method includes the forgoing operations and the determining of regions of interest further includes profiling applications that generate windows on the display and ranking content within the windows based on the profiling.

Another example method includes the forgoing operations and the first and the second levels of brightness are selected by the user.

Another example method includes the forgoing operations and the second level of brightness is selected to reduce power consumption of the display.

According to another aspect there is provided a system for adjusting display brightness. The system may include a region of interest determination module configured to determine regions of interest to a user on the display. The system of this example may also include a brightness adjustment module configured to adjust the display brightness in the regions of interest to a first level of brightness and adjust the display brightness in regions outside of the regions of interest to a second level of brightness, and the second level of brightness is lower than the first level of brightness.

Another example system includes the forgoing components and the region of interest determination module further includes a z-order determination module configured to determine the z-order of a plurality of windows generated on the display.

Another example system includes the forgoing components and the z-order determination module is further configured to obtain the z-order of the plurality of windows from a window manager.

Another example system includes the forgoing components and the region of interest determination module further includes an overlap determination module configured to determine the size and overlap of a plurality of windows generated on the display.

Another example system includes the forgoing components and the region of interest determination module further includes an application profiler module configured to profile applications that generate windows on the display.

Another example system includes the forgoing components and the region of interest determination module further includes a content region ranking module configured to rank content within the windows based on the application profiles.

Another example system includes the forgoing components and the first and the second levels of brightness are selected by the user.

Another example system includes the forgoing components and the second level of brightness is selected to reduce power consumption of the display.

According to another aspect there is provided at least one computer-readable storage medium having instructions stored thereon which when executed by a processor, cause the processor to perform the operations of the methods as described in the examples above.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

1-22. (canceled)

23. A system for adjusting display brightness, said system comprising:
a region of interest determination module configured to determine regions of interest to a user on said display; and
a brightness adjustment module configured to adjust said display brightness in said regions of interest to a first level of brightness and adjust said display brightness in regions outside of said regions of interest to a second level of brightness, wherein said second level of brightness is lower than said first level of brightness.

24. The system of claim 23, wherein said region of interest determination module further comprises a z-order determination module configured to determine the z-order of a plurality of windows generated on said display.

25. The system of claim 24, wherein said z-order determination module is further configured to obtain said z-order of said plurality of windows from a window manager.

26. The system of claim 23, wherein said region of interest determination module further comprises an overlap determination module configured to determine the size and overlap of a plurality of windows generated on said display.

27. The system of claim 23, wherein said region of interest determination module further comprises an application profiler module configured to profile applications that generate windows on said display.

28. The system of claim 27, wherein said region of interest determination module further comprises a content region ranking module configured to rank content within said windows based on said application profiles.

29. The system of claim 23, wherein said first and said second levels of brightness are selected by said user.

30. The system of claim 23, wherein said second level of brightness is selected to reduce power consumption of said display.

31. A method for adjusting display brightness, said method comprising:
determining regions of interest to a user on said display;
adjusting said display brightness in said regions of interest to a first level of brightness; and
adjusting said display brightness in regions outside of said regions of interest to a second level of brightness, wherein said second level of brightness is lower than said first level of brightness.

32. The method of claim 31, wherein said determining regions of interest further comprises determining the z-order of a plurality of windows generated on said display.

33. The method of claim 32, further comprising obtaining said z-order of said plurality of windows from a window manager.

34. The method of claim 31, wherein said determining regions of interest further comprises determining the size and overlap of a plurality of windows generated on said display.

35. The method of claim 31, wherein said determining regions of interest further comprises:
profiling applications that generate windows on said display; and
ranking content within said windows based on said profiling.

36. The method of claim 31, wherein said first and said second levels of brightness are selected by said user.

37. The method of claim 31, wherein said second level of brightness is selected to reduce power consumption of said display.

38. A computer-readable storage medium having instructions stored thereon which when executed by a processor result in the following operations for adjusting display brightness, said operations comprising:
determining regions of interest to a user on said display;
adjusting said display brightness in said regions of interest to a first level of brightness; and
adjusting said display brightness in regions outside of said regions of interest to a second level of brightness, wherein said second level of brightness is lower than said first level of brightness.

39. The computer-readable storage medium of claim 38, wherein said determining regions of interest further comprises determining the z-order of a plurality of windows generated on said display.

40. The computer-readable storage medium of claim 39, further comprising obtaining said z-order of said plurality of windows from a window manager.

41. The computer-readable storage medium of claim 38, wherein said determining regions of interest further comprises determining the size and overlap of a plurality of windows generated on said display.

42. The computer-readable storage medium of claim 38, wherein said determining regions of interest further comprises:
profiling applications that generate windows on said display; and
ranking content within said windows based on said profiling.

43. The computer-readable storage medium of claim 38, wherein said first and said second levels of brightness are selected by said user.

44. The computer-readable storage medium of claim 38, wherein said second level of brightness is selected to reduce power consumption of said display.
